(19) United States
(12) Patent Application Publication
(10) Pub. No.: US 2023/0020172 A1
(43) Pub. Date: Jan. 19, 2023

(54) METHOD OF MODIFYING AIR CONDITIONER FOR HEATING

(71) Applicant: GIOVANNI D. VOLO, MERIDEN, CT (US)

(72) Inventor: GIOVANNI D. VOLO, MERIDEN, CT (US)

(21) Appl. No.: 17/956,615

(22) Filed: Sep. 29, 2022

Related U.S. Application Data
(63) Continuation-in-part of application No. 15/487,344, filed on Apr. 13, 2017.

(51) Int. Cl. B23P 15/26; F24F 1/0326

(52) U.S. Cl. CPC B23P 15/26; F24F 1/0326

(57) ABSTRACT

The method of modifying an air conditioner for heating takes advantage of the features and operation of a conventional limited space air conditioner, such as a portable room air conditioner. A hood or manifold is placed over the vents or grille that normally exhausts cold air into the room, and a flexible duct hose is connected between the hood or duct and an exhaust vent installed in a window or ceiling to exhaust cold air produced by the air conditioner outside the building. The duct from the condenser or hot air side of the air conditioner, which would normally be exhausted outside the building, is open to the room in need of heating. Thus, the hot air produced by normal operation of the air conditioner is used to heat the room.

### CROSS-REFERENCE TO RELATED APPLICATION

This application is a continuation-in-part of U.S. patent application Ser. No. 15/487,344, filed on Apr. 13, 2017, the entire contents of which are hereby incorporated by reference.

### BACKGROUND

### 1. Field

The present invention relates to heating, ventilation, and air conditioning (HVAC) systems, and particularly to a method of modifying an air conditioner for heating.

### 2. Description of the Related Art

Many older buildings, e.g., historical buildings, were constructed in the days before central air conditioning systems and heat pump systems became common. The cost of retrofitting such buildings is often impractical, and in historical districts, the installation of ductwork may destroy architectural features that local zoning regulations are designed to preserve. In addition, many detached or semi-detached structures, such as sheds, workrooms, garages, etc., become very warm in the summer and cold in the winter. A common solution for the summer heat is a limited space air conditioner, such as a window air conditioner or a portable room air conditioner. During cold weather, heat may be provided by a radiator, by baseboard electric heaters, by kerosene space heaters, or the like.

Nevertheless, such heating or cooling systems are often inefficient or require supplemental heating or cooling. In addition, the use of separate systems to provide heating and cooling is energy inefficient. It would be desirable to use a limited space air conditioner to produce not only air conditioning, but heating when needed. Thus, a method of modifying an air conditioner for heating solving the aforementioned problems is desired.

### SUMMARY

The method of modifying an air conditioner for heating takes advantage of the features and operation of a conventional limited space air conditioner, preferably a portable room air conditioner. A hood or manifold is placed over the vents or grille that normally exhausts cold air into the room, and a flexible duct hose is connected between the hood or duct and an exhaust vent installed in a window or ceiling to exhaust cold air produced by the air conditioner outside the building. The duct from the condenser or hot air side of the air conditioner, which would normally be exhausted outside the building, is open to the room in need of heating. Thus, the hot air produced by normal operation of the air conditioner is used to heat the room.

A window air conditioner may also be modified to provide heating in the same manner. However, in this case, the window air conditioner is operated entirely within the room to be heated, and the cold air normally produced by the air conditioner is exhausted outside the building by a flexible duct hose, as described above. It can be seen that using the above method of modifying an air conditioner, no defrost control is involved in the process. In the heating mode, there is little to no condensation (as opposed to the water condensate which must be drained from a cooling air conditioner). When the air conditioning unit is used in the heating mode, air from the condenser 106 is discharged into the room to be heated, and the cooled air passing over the condenser coil is vented either outside or, alternatively, into a separate space that requires air conditioning (such as a computer room, an HVAC system, etc.), thus conserving energy. It should be understood that the method of modifying an air conditioner for heating may be applied to any desired type of air conditioner system. For example, the method may be used to modify window air conditioner units, portable air conditioners, package roof top heating systems, systems used for computer rooms, as an example, HVAC systems, etc.

These and other features of the present subject matter will become readily apparent upon further review of the following specification and drawings.

### BRIEF DESCRIPTION OF THE DRAWINGS

FIG. 1 is a block diagram of the refrigerant system components of a typical limited space air conditioner.

FIG. 2 is an environmental perspective view of a portable room air conditioner modified to supply heat according to the method of modifying an air conditioner for heating according to the present subject matter.

FIG. 3 is a schematic diagram of a second embodiment of an air conditioner modified to provide heating having a bypass duct inside the housing of the air conditioner.

FIG. 4 is a schematic drawing of a third embodiment of an air conditioner modified to provide heating having an electrical heating strip adjacent the evaporator coil.

Similar reference characters denote corresponding features consistently throughout the attached drawings.

### DETAILED DESCRIPTION OF THE PREFERRED EMBODIMENTS

The method of modifying an air conditioner for heating takes advantage of the features and operation of a conventional limited space air conditioner, by way of non-limiting example, a portable room air conditioner. A hood or manifold is placed over the vents or grille that normally exhausts cold air into the room, and a flexible duct hose is connected between the hood or duct and an exhaust vent installed in a window or ceiling to exhaust cold air produced by the air conditioner outside the building. The duct from the condenser or hot air side of the air conditioner, which would normally be exhausted outside the building, is open to the room in need of heating. Thus, the hot air produced by normal operation of the air conditioner is used to heat the room.

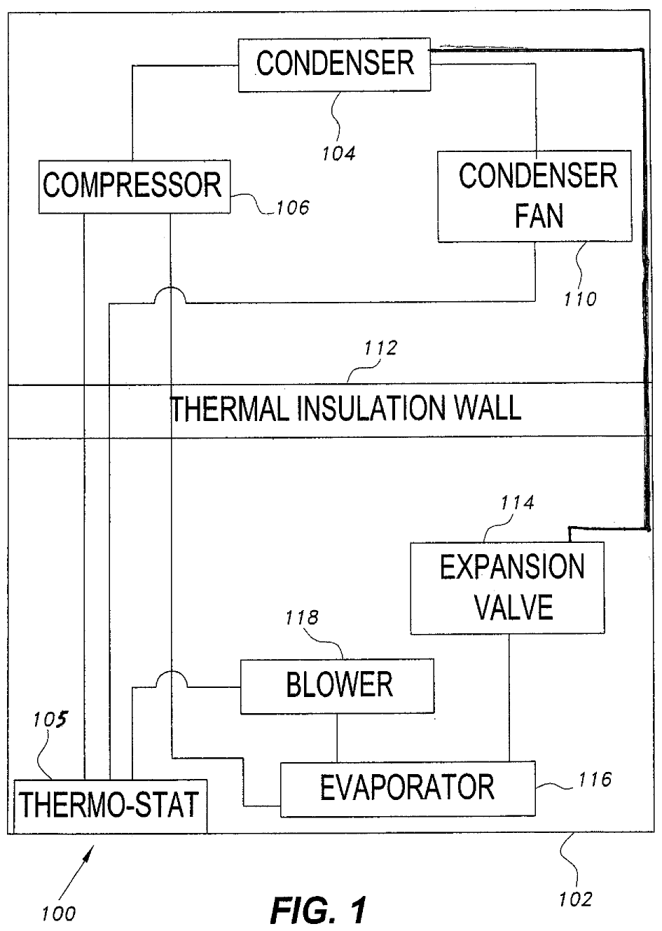

FIG. 1 shows the typical components of the refrigerant system of a limited space air conditioner 100. The air conditioner includes a cabinet or housing 102. A compressor 106, condenser 104, and condenser fan 110 are disposed on the hot side of the cabinet 102. An expansion valve 114, evaporator 116, and blower fan 118 are disposed on the cold side of the cabinet 102. Typically a wall of thermal insulation 112 will separate the room air (or cold side) from the outside air (or hot side) inside the cabinet 102. A thermostat 105 and other controls will be mounted on the cabinet 102. A window air conditioner will usually be mounted in the window with the condenser 104, compressor 106, and condenser fan 110 mounted outside the window. A portable room air conditioner will have all of these components disposed inside the cabinet 102 in the room to be cooled, with a flexible duct or exhaust hose connected between the condenser 104 and a window or ceiling vent to exhaust the hot air outside the building.

In operation as an air conditioner, when the temperature inside the room exceeds the temperature set on the thermostat 105, the compressor 106 turn on and compresses the refrigerant. The condenser fan 110 draws outside air (or room air) in and over the condenser coil. Even though the outside air is warm, it is still cooler than the refrigerant, which is hot and under high pressure, so that heat exchange with the outside air cools the refrigerant to a liquid in the condenser, while the hot air is blown outside by the condenser fan 110. The refrigerant is pumped to the expansion valve 114, where the refrigerant expands to a gas and is further cooled by expansion in the evaporator 116. The evaporator coil is cool almost immediately. The blower motor or blower fan 118 turns on and draws room air into the cabinet 102 and across the cold evaporator coils, where the room air is cooled and blown back into the room. The gaseous refrigerant is pumped from the evaporator 116 to the compressor 106, and the cycle is repeated until the room air is cooled. Any humidity in the room air is exhausted outside the building by the condenser fan 110, or condenses inside the cabinet 102 and drops to a collection tray, which is periodically empty.

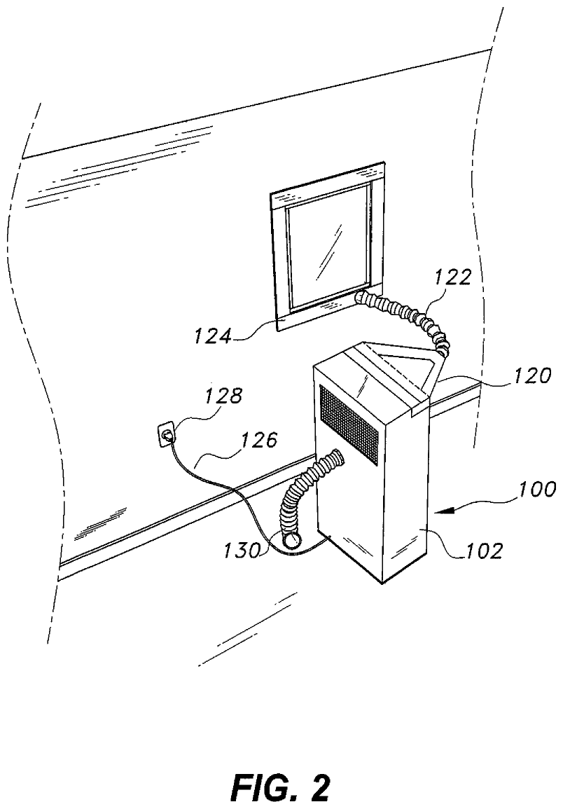

FIG. 2 shows a portable room air conditioner 100 modified to heat the room. A hood 120 is placed over the vents on the front panel of the cabinet 102 that would normally be used to return room air cooled by the evaporator 116 into the room. Instead, a flexible duct or exhaust hose 122 is connected between the hood 120 and a window 124 vent. The hood 120, by way of non-limiting example, may be made from flexible thermal insulation with aluminum backing and secured to the cabinet 102 by duct tape or the like. Alternatively, depending upon the size of the cool air vents, a pyramidal or horn-shaped section of sheet metal duct, or other suitable material, may be secured to the cabinet 102 by screws or other fasteners and sealed by a gasket or by caulk. A plate of sheet metal or other suitable material may be attached across the open end of the sheet metal duct, and a circular flange may be provided for attachment of the flexible duct 122. In any event, the cold air produced by the air conditioner 100 is vented outside.

The flexible hose 130 attached to the rear of the cabinet, which receives the hot air from the compressor 106 and the condenser 104 and which is exhausted by the condenser fan 110, is open into the room to be heated. Thus, the heat normally produced by operation of the air conditioner is used to heat the room. Although illustrated by a portable room air conditioner connected to an electrical outlet by a cord 126 and plug 128 in FIG. 2, the same principles may be used to modify a window air conditioner for heating. The cabinet of the window air conditioner would be placed completely inside the room to be heated, the cold air vents would be covered by a hood or manifold and ducted outside the building through a window or ceiling vent, and the hot air vents would be open to the interior of the room to be heated. In either case, a suitable collector may be provided to collect condensation from normal operation of the air conditioner unit.

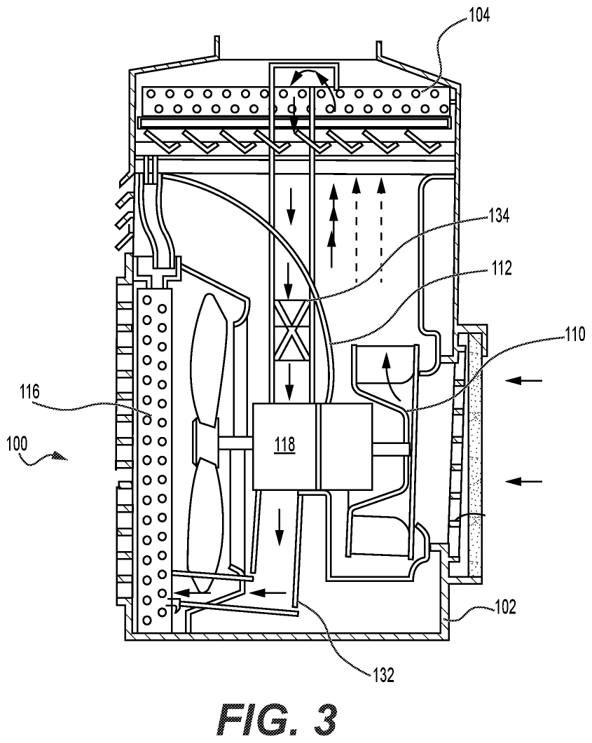

Reversal of operation of the air conditioning unit may be controlled easily without requiring, for example, a reversing valve. As shown in FIG. 3, a bypass hose or duct 132, along with any associated connectors, ductwork, dampers, etc., may be used to transfer thermal energy (air flow) through the thermally insulated wall 112 separating the condenser side from the evaporator side of the housing 102 directly from the air conditioner's condenser 104 to its evaporator 116. In operation, this increases the pressure and heat load on the evaporator 116, and then increases the load on the condenser 104 to produce more heat for venting into the room or building requiring heating. As room temperature increases, a modulator or modulation controller may be used to slowly close off the damper 134 disposed in the bypass hose or duct 132 to slow or cease venting of the room air from the condenser 104 through the bypass hose or duct 132 to the evaporator 116. In one embodiment, the dampers are motorized dampers or the like, although manual dampers may also be used.

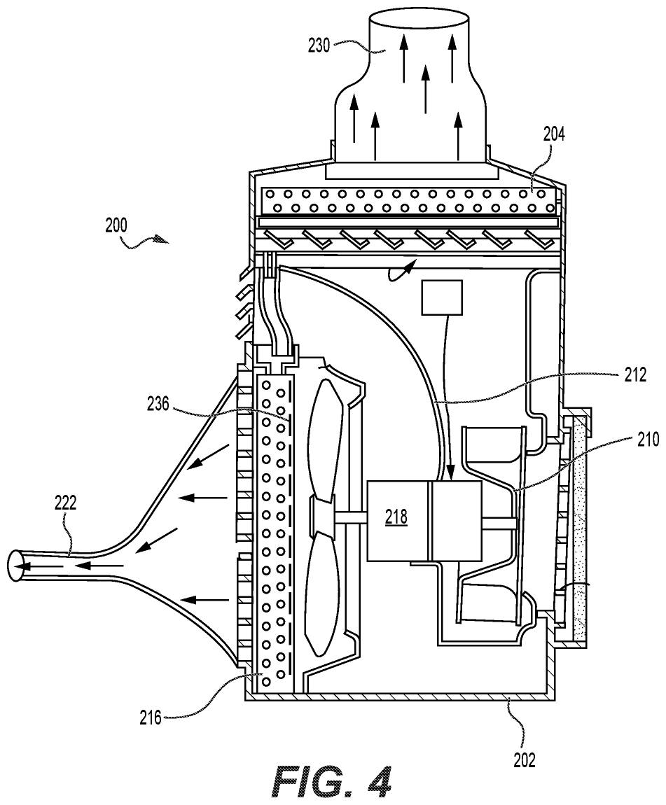

The above operation may be used on cold startup or as required. When the evaporator side of the system requires more of a load on the evaporator 116 to create more heat, the damper 134 will open or close, as needed, from the condenser 104 to the evaporator 116. Hot air from the condenser will pass to the evaporator side and heat will be transferred from the hot air passing over the evaporator coil to the refrigerant inside the evaporator coil, and the resulting cold air will be exhausted out of the room or building in need of heating. The hot refrigerant will pass to the compressor 106 and be converted to a liquid state, the heat generated by the work done by the compressor 106 being passed to the air in the condenser 104, the air passing over the condenser coil also absorbing heat from the refrigerant, and the heated air in the condenser 104 is drawn into the room or building requiring heating. As an alternative, as shown in FIG. 4, an electrical heating strip 236 or the like may be added to create an increased load on the evaporator 216. FIG. 4 is similar to FIG. 3, showing an air conditioner 200 modified to provide heating, the air conditioner 200 having a housing 202, a condenser 204, a condenser fan 210, a thermal insulation wall 212 separating the inside of the air conditioner 200 into a condenser (or high or hot side) and an evaporator (or low or cold side), an evaporator 216, a blower motor 218, a flexible duct or exhaust hose exhausting cold air from the evaporator side outside or away from the room or building requiring heating, a flexible hose carrying hot air from the condenser side into the room or building requiring heating, and the electrical heating strip 236 positioned to pass hot air over the evaporator coil. The present method of modifying an air conditioner allows a single unit to be used all year, operating in both a cooling air conditioning mode as well as in a heating mode. In addition to the manual or automatic switching of operation described above, a further alternative includes the addition of a modulated reversible motor, allowing for the controllable change of air direction.

It can be seen that using the above method of modifying an air conditioner, no defrost control is involved in the process. In the heating mode, there is little to no condensation (as opposed to the water condensate, which must be drained from an air conditioner in cooling mode). When the air conditioning unit is used in the heating mode, air from the condenser 104 is discharged into the room to be heated, and the cooled air passing over the evaporator coil is vented either outside or, alternatively, into a separate space that requires air conditioning (such as a computer room, an HVAC system, etc.), thus conserving energy.

It should be understood that the method of modifying an air conditioner for heating may be applied to any desired type of air conditioner system. For example, the method may be used to modify window air conditioner units, portable air conditioners, package roof top heating systems, systems used for computer rooms, as an example, HVAC systems, etc. Similarly, it should be understood that the present method may be used in combination with any conventional type of air conditioner controller, such as, for example, conventional thermostats, timers, programmable systems including programmable logic controllers and the like, sensors, remote controls, direct user interfaces (buttons, switches, etc.), telephone control and the like. Further, it should be understood that conventional air conditioner components may be used with the modified air conditioner, such as, for example, conventional filters and the like for filtering the air from the supply and the return.

It should be understood that the components used in the present method, such as flexible hose 130, hood 120, the optional bypass hose, along with any associated connectors, ductwork, venting, etc., may be made from any suitable material, such as, but not limited to, metal, plastic, carbon, carbon fiber or the like. Similarly, any connectors, hardware, fixtures, fittings and the like may be formed from any suitable material, and any suitable type of connections may be used, such as, for example, Velcro® (hook-and-loop fastening material), straps, screws, etc.

It is to be understood that the method of modifying an air conditioner for heating is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A method of modifying an air conditioner for heating, the air conditioner having:
a housing defining an interior and a front surface having vents defined therein for removing warm air from an area to be cooled and venting cool air into the area to be cooled when the air conditioner is operated in cooling mode;
a thermostat mounted on the housing;
a thermal insulation wall disposed in the interior of the housing, separating the interior of the housing into two compartments;
a compressor, a condenser, and a condenser fan disposed in one of the two compartments, defining a hot side of the housing;
an expansion valve, an evaporator, and a blower fan disposed in the other one of the two compartments, defining a cold side of the housing, the expansion valve being connected between the condenser and the evaporator and adapted for transferring refrigerant between a coil in the condenser and a coil in the evaporator;
a flexible hose connected to the hot side of the housing diverting hot air produced in the hot side of the housing away from the area to be cooled when the air conditioner is operated in the cooling mode;
the method comprising the steps of:
covering the vents in the front surface of the housing venting cool air into the area to be cooled when the air conditioner is operated in cooling mode with a hood and connecting a flexible duct to the hood diverting the cool air away from an area to be heated when operating the air conditioner in heating mode;
redirecting the flexible hose connected to the hot side of the housing into the area to be heated when operating the air conditioner in heating mode;
connecting a bypass hose having a damper therein between the condenser in the hot side of the housing and the evaporator in the cold side of the housing, the bypass hose extending through the thermal insulation wall;
opening the damper in the bypass hose to pass air from the hot side of the housing to the cold side of the housing when the air conditioner is operated in the heating mode, thereby increasing load on the evaporator and subsequently increasing load on the condenser to generate more heat for heating the area to be heated; and
circulating the hot air generated in the condenser through the flexible hose connected to the hot side of the housing into the area to be heated when operating the air conditioner in heating mode.

2. The method of modifying an air conditioner according to claim 1, further comprising the step of closing the damper in the bypass hose when temperature in the area to be heated has risen to a desired heat level.

3. A method of modifying an air conditioner for heating, the air conditioner having:
a housing defining an interior and a front surface having vents defined therein for removing warm air from an area to be cooled and venting cool air into the area to be cooled when the air conditioner is operated in cooling mode;
a thermostat mounted on the housing;
a thermal insulation wall disposed in the interior of the housing, separating the interior into two compartments;
a compressor, a condenser, and a condenser fan disposed in one of the two compartments, defining a hot side of the housing;
an expansion valve, an evaporator, and a blower fan disposed in the other one of the two compartments, defining a cold side of the housing, the expansion valve being connected between the condenser and the evaporator and adapted for transferring refrigerant between a coil in the condenser and a coil in the evaporator;
a flexible hose connected to the hot side of the housing diverting hot air produced in the hot side of the housing away from the area to be cooled when the air conditioner is operated in the cooling mode;
the method comprising the steps of:
covering the vents in the front surface of the housing venting cool air into the area to be cooled when the air conditioner is operated in cooling mode with a hood and connecting a flexible duct to the hood diverting the cool air away from an area to be heated when operating the air conditioner in heating mode;
redirecting the flexible hose connected to the hot side of the housing into the area to be heated when operating the air conditioner in heating mode;
mounting an electrical heating strip in the evaporator in a position to heat air drawn through the evaporator;
turning the electrical heating strip on when the air conditioner is operated in the heating mode, thereby increasing load on the evaporator and subsequently increasing load on the condenser to generate more heat for heating the area to be heated; and
circulating the hot air generated in the condenser through the flexible hose connected to the hot side of the housing into the area to be heated when operating the air conditioner in heating mode.

4. The method of modifying an air conditioner according to claim 3, further comprising the step of turning the electrical heating strip off when temperature in the area to be heated has risen to a desired heat level.
